(19) United States
(12) Patent Application Publication
(10) Pub. No.: US 2018/0131995 A1
(43) Pub. Date: May 10, 2018

(54) METHOD FOR RENDERING AUDIO-VIDEO CONTENT, DECODER FOR IMPLEMENTING THIS METHOD AND RENDERING DEVICE FOR RENDERING THIS AUDIO-VIDEO CONTENT

(71) Applicant: NAGRAVISION S.A., Cheseaux-sur-Lausanne (CH)

(72) Inventor: Philippe STRANSKY-HEILKRON, Cheseaux-sur-Lausanne (CH)

(73) Assignee: NAGRAVISION S.A., Cheseaux-sur-Lausanne (CH)

(21) Appl. No.: 15/572,248

(22) PCT Filed: May 3, 2016
(86) PCT No.: PCT/EP2016/059901

§ 371 Date: Nov. 7, 2017

(30) Foreign Application Priority Data
May 8, 2015 (EP) 15166999.1

(51) Int. Cl. H04N 21/4363; H04N 21/81

(52) U.S. Cl. CPC H04N 21/43635; H04N 21/8193; H04N 21/8186

(57) ABSTRACT

A decoder comprises an input interface for receiving audio-video content in a compressed form, an output interface for outputting said compressed audio-video content, at least one application frame relating to at least one application service, and control data, wherein the control data comprises identification data and implementation data, the identification data being used for identifying at least a part of the audio-video content and/or a part of the at least one application frame, and the implementation data defining the rendering of at least one of the audio-video content and the at least one application frame.

### BACKGROUND

Commonly called set-top-box, a decoder is consumer premises equipment to receive compressed audio-video content. The content is traditionally decompressed by the decoder before being sent in an intelligible form to a rendering device. If need be, the content is decrypted by the decoder before being decompressed. The rendering device could be a video display screen and/or audio speakers. In the present description, a television capable of rendering high definition video images will be taken as a non-limiting example of rendering device.

As the function of the decoder is to process the content received from a broadcaster (or from any other source) before delivering it to a television, the decoder is located upstream from the television. The decoder may be connected to the television through a wired cable, typically through a High Definition Multimedia Interface (HDMI). Such an interface has been initially designed for transmitting an uncompressed audio-video stream from an audio-video source towards a compliant receiver.

A high definition television having a Full HD video format is able to display an image including 1080 lines of 1920 pixels each. This image has a definition equal to 1920×1080 pixels in a 16:9 aspect ratio. Each image in Full HD format comprises 2 megapixels. Today, with the emergence of Ultra High Definition (UHD 4K, also called UHD-1) formats, compliant televisions are able to offer 8 million pixels per image, and the UHD 8K (UHD-2) provides images with more than 33 million pixels with further improved color rendering. Increasing the resolution of the television provides for a finer image and mostly allows for an increase in the size of the display screen. Moreover, increasing the size of the television screen improves the viewing experience by widening the field of view and by allowing for immersion effects to be realised.

Besides, by providing a high image-refresh rate, it becomes possible to improve the sharpness of the image. This is particularly useful for sports scenes or travelling sequences. Thanks to new digital cameras, film producers and directors are encouraged to shoot movies at a higher frame rate. Using HFR (High Frame Rate) technology it is possible to achieve frame rates of 48 fps (frames per second), 60 fps or even 120 fps, instead of 24 fps commonly used in the film industry. However, if one wants to extend the delivery chain of these cinematographic works up to the home of the end user, it is also necessary to create televisions which are suitable for rendering audio/video received at these higher frame rates. Moreover, to avoid jitter and stroboscopic effects and/or to mitigate lack of sharpness of the image during scenes having rapid movements, the next generation of UHD video streams (UHD 8K) will be provided at 120 fps.

However, the interfaces, such as HDMI, implemented in the decoder and in the television for transmitting the audio-video stream were not designed for transmitting such large amounts of data at such high bit rates. The last version of the HDMI standard (HDMI 2.0) supports up to 18 GB/s. Therefore, HDMI 2.0 just allows for the transmission of a UHD 4K audio-video stream provided at 60 fps. This means that an HDMI interface becomes insufficient to ensure the transmission of images having higher resolution at the same high bit rate, for instance a UHD 8K video at 60 fps or higher.

In the near future, the data bit rates between the decoder and the rendering device will grow further, in particular by increasing the bit depth of the images, from 8 bits up to 10 or 12 bits. Indeed, by increasing the color depth of the image it becomes possible to smooth the color gradation and therefore to avoid the banding phenomenon. Currently, an HDMI 2.0 interface is unable to transmit UHD videos at 60 fps with 10 or 12-bits color depth.

The discontinuation of 8-bits color depth in television of the next generation will also contribute to the development of a new feature called High Dynamic Range (HDR). This feature requires at least 10-bits color depth. The HDR standard aims to amplify the contrast ratio of the image in order to display a very bright picture. The goal of HDR technology is to allow for the pictures to be so bright that it is no longer necessary to darken the room. However, current interfaces, such as HDMI, are not flexible enough to comply with the HDR standard. This means that HDMI is simply not compliant with the new HDR technology.

The decoder is also considered as being an important device for content providers because each of them can offer attractive specific functions through this device to enhance the viewing experience. Indeed, since it is located upstream within the broadcast chain with respect to the rendering device, the decoder is able to add further information to the content after having decompressed the input audio-video content received from the content provider. Alternatively, the decoder can modify the presentation of the audio-video content on the display screen. Generally speaking, the decoder could add further information and/or modify the presentation of the audio-video content so as to offer numerous applications to the end user.

Among these applications, the provider can offer, for example, an EPG (Electronic Program Guide), a VoD (Video on Demand) platform, a PiP (Picture in Picture) display function, intuitive navigation tools, efficient searching and programming tools, access to Internet pages, help functions, parental control functions, instant messaging and file sharing, access to personal music/photo library, video calling, ordering services, etc. . . . . These applications can be regarded as being computer-based services. Accordingly, they are also referred as “application services”. By providing a wide range of efficient, practical and powerful application services, one can immediately understand the real interest in supplying set-top-boxes with such functionalities. This interest is beneficial both for the end user and the provider.

Therefore, there is an interest to take advantage of all the functionalities provided by the new technologies embedded in the next generations of UHD devices, including for decoders or multimedia systems comprising at least a decoder connected to a rendering device.

Document US 2011/0103472 discloses a method for preparing a media stream containing HD video content for transmission over a transmission channel. More specifically, the method of this document suggests to receive the media stream in a HD encoding format that does not compress the HD video content contained therein, to decode the media stream, to compress the decoded media stream, to encapsulate the compressed media stream within an uncompressed video content format and to encode the encapsulated media stream using the HD format so as to produce a data stream that can be transmitted through an HDMI cable or a wireless link. In some instances, the media stream can also be encrypted.

Document US 2009/0317059 discloses a solution to use HMDI standard for transmitting auxiliary information, including additional VBI (Vertical Blanking Interval) data. To this end, this document discloses an HDMI transmitter which comprises a data converting circuit for converting data formats of incoming audio, video and auxiliary data sets, into formats compliant with the HDMI specification, so as to transmit the converted multimedia and auxiliary data sets through an HDMI cable linking the HDMI transmitter to an HDMI receiver. The HDMI receiver comprises a data converting circuit to perform the reverse operation.

Document US 2011/321102 discloses a method for locally broadcasting audio/video content between a source device equipped with an HDMI interface and a target device, the method including: compressing the audio/video content in the source device; transmitting the compressed audio/video content over a wireless link, from a transmitter associated with the source device, the transmitter receiving the audio/video content from the HDMI interface of the source device, and receiving the compressed audio/video content using a receiver device.

Document US 2014/369662 discloses a communication system wherein an image signal, having content identification information inserted in a blanking period thereof, is sent in the form of differential signals through a plurality of channels. On the reception side, the receiver can carry out an optimum process for the image signal depending upon the type of the content based on the content identification information. The identification information inserted by the source for identifying the type of content to be transmitted is located in an Info-Frame packed placed in a blanking period. The content identification information includes information of the compression method of the image signal. The reception apparatus may be configured such that the reception section receives a compressed image signal inputted to an input terminal. When the image signal received by the reception section is identified as a JPEG file, a still picture process is carried out for the image signal.

### BRIEF DESCRIPTION OF THE DRAWINGS

The subject matters of the present description will be better understood thanks to the attached figures in which:

FIG. 1 schematically depicts an overview of the data streams passing through a multimedia system, according to the basic approach of the present description,

FIG. 2 is a more detailed schematic illustration of the decoder shown in FIG. 1.

### DETAILED DESCRIPTION

The present description suggests a solution based on an ability provided by almost all the modern rendering devices. This ability is not yet exploited by decoders or multimedia systems comprising a decoder and a rendering device.

According to a first aspect, the present description relates to a method for rendering (i) audio-video data from audio-video content and (ii) at least one application frame relating to at least one application service. This method comprising:
receiving, by the decoder, said audio-video content in a compressed form,
outputting, from the decoder: the audio-video content in said compressed form, at least one application frame relating to at least one application service, and control data. Control data aims to describes the way to form the audio-video data from the audio-video content and the at least one application frame.

According to one specific feature of the present description, identification data and implementation data are included in said control data. Identification data is used for identifying at least a part of said audio-video content and/or a part of said at least one application frame. Implementation data defines the rendering of at least one of said audio-video content and said at least one application frame.

Thanks to this feature, implementation data remains under the control of the decoder and remains easily updatable at any time, for example by the Pay-TV operator who may supply the decoder with not only the audio-video content, but also with numerous application services.

Advantageously, the pay-TV operator may control, through the decoder, the payload (i.e. the audio-video content and the application frames) and the implementation data which defines how to present this payload, so as to obtain the best result on the rendering device of the end-user.

The audio-video content can be received from a video source such as a content provider or a head-end, by means of at least one audio-video main stream used for carrying audio-video content. As received by the decoder, the audio-video content is not decompressed by the decoder. Indeed, this audio-video content simply goes through the decoder so as to reach the rendering device in a compressed form, preferably in the same compressed form as it was received at the input of the decoder.

Firstly, this approach allows for the transmission of UHD audio-video streams at high bit-rates between a decoder and a rendering device, so that the full capacities of the next generations of UHD-TV (4K, 8K) can be used when such receivers are connected to a set-top-box. Secondly, this approach also takes advantage of the application services provided by the decoder, in particular simultaneously to the delivery of the audio-video content from the decoder to the rendering device. This means that the present description also provides a solution for transmitting, at high bit rates, not only huge amounts of data resulting from the processing of UHD video streams, but also application data. The quantity of this application data to be transmitted together with UHD audio-video content may be very significant.

Furthermore, the present description also provides for the optimisation of certain functions of a system comprising both a decoder and a rendering device. Indeed, almost all rendering devices are already provided with decompression means, often with more efficient and powerful technologies than those implemented in the decoder. This mainly results from the fact that the television market evolves much faster than that of the decoders. Accordingly, there is an interest both for the consumer and the manufacturer to process the decompression of the content within the rendering device, instead of entrusting this task to the decoder, as has been done so far.

Other advantages and embodiments will be presented in the following description.

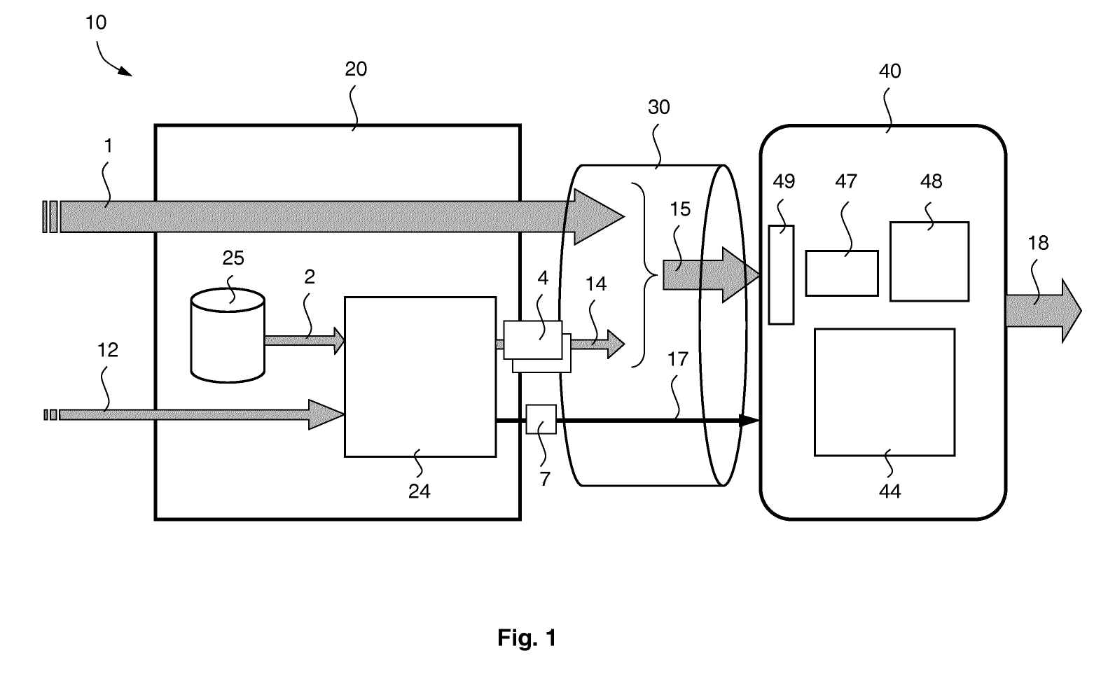

FIG. 1 schematically shows an overview of a multimedia system 10 comprising a decoder 20 and a rendering device 40 connected to the decoder by mean of a data link 30. For instance, the data link 30 can be a wired HDMI connection. The rendering device 40 may typically be a television, a beamer, a play station, a computer or any other device suitable for outputting intelligible audio-video data 18 displayable on a screen. Although not being illustrated in the attached Figures, the screen can be either integrated within the rendering device (e.g. a TV display screen) or separated from the latter (e.g. a screen to be used with a beamer of a home cinema).

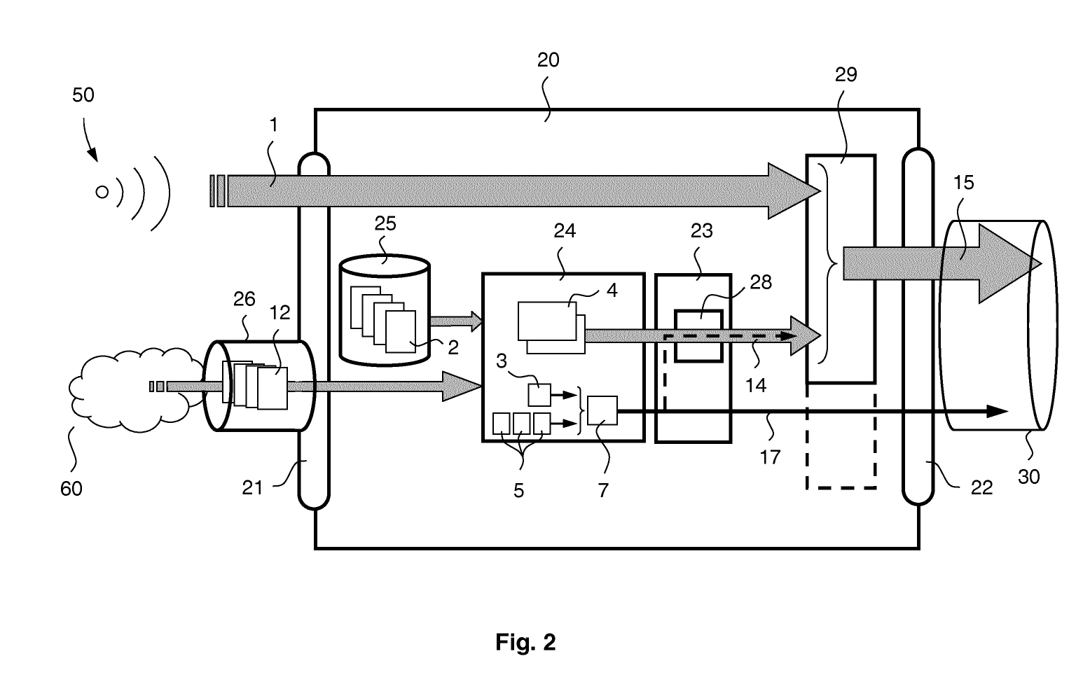

The decoder 20 is configured to receive, e.g. through at least one audio-video main stream, audio-video content 1 in a compressed form. Such an audio-video content 1 would be understood by one of skill in the art as being any kind of content that can be received by a decoder. In particular, this content 1 could refer to a single channel or to a plurality of channels. For instance, this content 1 could include the audio-video streams of two channels, as they are received e.g. by a system suitable to provide a PiP function. Audio-video data 18 would be understood as being any data displayable on a screen. Such data can comprise the content 1, or a part of this content, and could further include other displayable data such as video data, text data and/or graphical data. Audio-video data 18 specifically refers to the video content that will be finally displayed on the screen, i.e. to the video content which is output from the rendering device 40. The audio-video main stream can be received from a content provider 50, as better shown in FIG. 2. The content provider may be for example a broadcaster or a head-end for broadcasting an audio-video stream through any network, for instance through a satellite network, a terrestrial network, a cable network, an Internet network, or a handheld/mobile network. The audio-video main stream may be part of a transport stream, namely a set of streams containing simultaneously several audio-video main streams, data streams and data table streams.

The method suggested in the present description is for rendering audio-video data 18, from audio-video content 1 and from at least one application frame 4 which relates to at least one application service. An application frame 4 can be regarded as being a displayable image whose content relates to a specific application service. For instance, an application frame could be a page of an EPG, a page for searching events (movies, TV programs, etc. . . . ), or a page for displaying an external video source and/or an event with scrolling information or banners containing any kind of message. Accordingly, application frames may contain any data which can be displayed on a screen, such as video data, text data and/or graphical data for example.

The basic form of the method comprises the following steps:
receiving, by the decoder 20, the audio-video content 1 in a compressed form,
outputting, from the decoder 20:
   the audio-video content 1 in the aforementioned compressed form,
   at least one application frame 4 relating to at least one application service, and
   control data 7.

This method, is characterized by the fact that it comprises a step for including identification data 3 and implementation data 5 in the aforementioned control data 7. As better shown in FIG. 2, control data 7 may comprise identification data 3 and implementation data 5.

Identification data 3 can be used for identifying at least a part of data to be displayed on a screen, namely at least a part of audio-video content and/or a part of the aforementioned application frame(s) 4 which are referred as displayable data 15, both in the following description and in FIGS. 1 and 2. Typically, identification data may take the form of a stream identifier and/or a packet identifier.

Implementation data 5 defines the rendering of the audio-video content 1 and/or at least one application frame 4. To this end, implementation data may defines implementation rules for rendering at least a part of the aforementioned displayable data 15 that has to be sent to the rendering device 40. Accordingly, implementation data 5 defines how said at least part of displayable data 15 has to be presented or rendered on a screen.

Such a presentation may depend on the size of the screen, the number of audio-video main streams which have to be simultaneously displayed or whether some text and/or graphical data has to be simultaneously displayed with a video content, for example. The presentation depends on the related application services and, for instance, may involve resizing or overlaying any kind of displayable data 15. Overlaying displayable data may be achieved with or without transparency.

Accordingly, implementation data 5 may relate to dimensions, size and positions of target areas for displaying displayable data 15, priority rules for displaying said data or specific effects such as transparency to be applied when displaying said data. In one embodiment, implementation data relates to data or parameters defining at least a displaying area and a related position within a displayable area. This displayable area may be expressed in terms of the size of the display screen, for example.

In other words, implementation data defines the rendering of at least one of the audio-video content 1 and at least one application frame 4. This rendering is the presentation of the audio-video content and/or the application frame on the rendering device (e.g. the display screen of the end-user device). In other words, the rendering is the appearance of the audio-video content and/or the application frame on the rendering device. This appearance may relate to the position of audio-video content and/or the position of the application frame on the rendering device. This position may be an absolute position on the display screen or it may be a relative position, for example a relative position between the audio/video content and the at least one application frame. This appearance may relate to the size of window(s) into which the audio-video content and/or the application frame are displayed on the rendering device. Any of these windows may be displayed with an overlay on other data or other window(s) and this overlay may be with or without transparency effect. These parameters (position, size, overlay, transparency, etc. . . . ) may be combined in any manner for appearance purposes. Other parameters (e.g. colors, windows frame lines or any other viewing effects or preferences) may also be considered.

Advantageously, the present method does not perform any decompression operations, in particular for decompressing the compressed audio-video content 1. This means, that the audio-video content 1 is not even decompressed then re-compressed by the decoder, before being output from the decoder 20 towards the rendering device 40. According to one embodiment, this audio-video content 1 simply transits through the decoder 20 without being processed.

Thanks to the present method, the bandwidth between the decoder 20 and the rendering device 40 can be reduced so that any known transmission means providing high bit rates can be used for transmitting UHD streams at high bit rates.

Although the description of this first embodiment refers to a decoder, one could also replace this decoder by any content source that would be suitable for delivering UHD video content towards the rendering device. This content source could be any device, e.g. an optical reader for reading Ultra HD Blu-ray.

In the pay-TV field, the audio-video main streams are often received in an encrypted form. The encryption is performed by the provider or the head-end according to an encryption step. According to one embodiment, at least a part of the audio-video content received by the decoder 20 is in an encrypted form. In this case, the audio-video main stream carries at least said audio-video content 1 in an encrypted and compressed form. Preferably such audio-video content has been first compressed before being encrypted. In accordance with this embodiment, the method may further comprise a step for decrypting, by the decoder 20, the received audio-video content before outputting said audio-video content in said compressed form.

Control data 7 can be received from a source external to the decoder 20, for example through a transport stream, as a separate data stream or together with the audio-video main stream. Alternatively, control data 7 may also be provided by an internal source, namely a source located within the decoder. Accordingly, control data 7 may be generated by the decoder 20, for example by an application engine 24 shown in FIG. 2.

According to another embodiment, the aforementioned at least one application frame 4 is received by the decoder 20 from a source external to this decoder. Such an external source can be identical, distinct or similar to that which provides the control data 7 to the decoder. Alternatively, the aforementioned at least one application frame 4 may be generated by the decoder itself. Accordingly, the decoder 20 may further comprise the application engine 24 for generating application frames 4.

As shown in FIG. 1, the rendering device 40 may further comprise a control unit 44 configured to deploy an application service that allows for the presentation of all or a part of displayable data 15 in accordance with the aforementioned implementation data 5, for example through implementing rules. Therefore, it should be understood that the application engine 24 of the decoder generates an application service by providing control data 7 relating to at least a part of displayable data 15 sent to the rendering device, so that the control unit 44 can use both said control data 7 and at least a part of displayable data to deploy the application service within the rendering device. In other words, this means that the control unit 44 generates intelligible audio-video data 18 corresponding to a specific application service which is obtained on the basis of both said control data 7 and at least a part of displayable data. Accordingly, the intelligible audio-video data 18 encompasses a particular presentation of at least a part of said displayable data 15 and the specific nature of this presentation is defined by the control data 7 which may be suitable for implementing implementation rules. To this end, the control unit 44 may use system software stored in a memory of this unit.

According to a further embodiment, at least one of the application frames 4 is based on application data 2 coming from the decoder 20 and/or from at least one source external to the decoder. Application data 2 may be regarded as being any source data that can be used for generating an application frame 4. Accordingly, application data 2 relates to raw data which may be provided to the decoder from an external source, for example through a transport stream or together with the audio-video main stream. Alternatively, raw data could also be provided by an internal source, namely a source located within the decoder such as an internal database or storage unit. The internal source can be preloaded with application data 2 and could be updated with additional or new application data 2, for instance via a data stream received at the input of the decoder. Therefore, the application data may be internal and/or external data.

Besides, it should be noted that the transmission from the decoder 20 to the rendering device 40 of the audio-video content 1, the application frame(s) 4 and the control data 7 is carried out through the data link 30. As illustrated in the FIGS. 1 and 2, the data link 30 is a schematic representation of one or several connecting means between these two entities 20, 40. Accordingly, these streams, frames and data could be transmitted in different ways, through one or several transmission means. Preferably, the data link 30 or one of these transmission means is a HDMI connecting means.

Once the related application service has been prepared by the control unit 44, the rendering device 40 sends this application service, towards its output interface, as being audio-video data 18 that has to be e.g. displayed on a suitable screen.

As shown in FIGS. 1 and 2, application data coming from any source which is external to the decoder 20, or external to the multimedia system 10, is referred as external application data 12. In the case where at least a part of application data is qualified as being external application data 12, the method further comprises the steps of:
receiving, at the decoder 20, external application data 12, and
using said external application data 12 as application data 2 for generating the application frame(s) 4.

This means that external application data 12 and internal application data are processed by the application engine 24 in the same way, namely as being application data 2.

According to one embodiment, the application frame(s) 4 is/are output from the decoder 20 through an application sub-stream 14 which is distinct from the stream through which the compressed audio-video content is output. In this case, the application sub-stream 14 can be regarded as being a standalone stream that can be sent in parallel with the audio video content contained in the audio-video main stream. For example, the sub-stream 14 can be sent within the same communication means as that used for outputting the audio-video content from the decoder 20. Alternatively, the sub-stream 14 can be sent within a separate communication means.

In addition, as the application sub-stream 14 is fully distinct from the compressed audio-video main stream(s), therefore it can advantageously be sent either in a compressed form or in a decompressed form, irrespectively from the form of audio-video content within the main stream(s). According to one embodiment, application frame(s) 4 of the application sub-stream 14 is/are sent in a compressed form in order to further reduce the required bandwidth of the data link 30 between the decoder 20 and the rendering device 40. To this end, the method further comprises the steps of:
compressing the application sub-stream 14 at the decoder 20 before its output from the decoder 20.

In the same way as for the compressed audio-video content, the compressed application frame(s) can be decompressed at the rendering device 40 before deploying the application service. This last stage intends to decompress data of the application sub-stream 14 at the rendering device 40 before generating, at the control unit 44, the audio-video data 18 which includes at least a part of displayable data 15 (i.e. audio-video content and/or application frames) output from the decoder 20. This displayable data being presented in accordance with a specific presentation defined by the aforementioned control data 7, especially by the implementation data 5 included in the control data 7.

Within the rendering device, the decompression of the compressed data carried by the application sub-stream 14 can be advantageously performed by the same means as those used for decompressing the compressed audio-video content 1 carried by the audio-video main stream.

According to another embodiment, the application sub-stream 14 can be further multiplexed with any audio-video main stream(s) at the decoder 20, before outputting them from the decoder, namely before the transmission of these stream(s) and sub-stream towards the rendering device 40. In this case, the rendering device 40 should be able to demultiplex the streams/sub-streams received from the decoder, before processing them for deploying the application service, in particular for generating the audio-video data 18 corresponding to this application service. Accordingly, the method may further comprise the steps of:
multiplexing the application sub-stream 14 together with the aforementioned at least one compressed audio-video main stream, at the decoder 20, before their output from the decoder.

In one embodiment, control data 7 is inserted within the application sub-stream 14, so that the application sub-stream 14 carries both the application frame(s) 4 and control data 7. Within such a sub-stream, control data 7 may be identified for instance by using a specific data packet or through a specific data packet header. Accordingly, control data 7 and application frames 4 remain identifiable each others, even if they are interleaved in the same sub-stream 14.

In an example embodiment, control data 7 is transmitted in at least one header, through the application sub-stream 14. Such a header may be a packet header, in particular a header of a packet carrying frame (4) data. It may also be a stream header, in particular a header placed at the beginning of the application sub-stream 14 prior to its payload. Indeed, as control data 7 mainly concerns identifiers and setting parameters used for defining how the related displayable data 15 must be presented, such identifiers and setting parameters do not represent a large amount of information. Therefore, control data could stand in packet headers and/or in stream headers.

In a further embodiment, control data 7 is transmitted through a control data stream 17 which can be regarded as being a standalone stream, namely a stream which is distinct from any other streams. Preferably, the control data stream 17 is transmitted in parallel to the displayable data 15, either within the same communication means or through a specific communication means.

Generally speaking, control data 7 can be transmitted either through a control data stream 17 or through the application sub-stream 14.

In addition, at least one of the aforementioned outputting steps performed by the decoder 20 is preferably carried out through a HDMI means, such as a HDMI cable for example. It should be noted that the HDMI communications are generally protected by an HDCP protocol which defines the frame of data exchange. HDCP adds an encryption layer to an unprotected HDMI stream.

HDCP is based on certificates verification and data encryption. Before the data is outputted by a source device, a handshake is initiated during which the certificate of the source and the sink are exchanged. The received certificate (e.g. X509) is then verified and used to establish a common encryption key. The verification can use white or black lists.

Referring more specifically to FIG. 2, the decoder 20 used for implementing the above method, will be now described in more details.

As shown in FIG. 2, the decoder 20 comprises an input interface 21 for receiving at least audio-video content 1 in a compressed form, for example within at least one audio-video main stream. Preferably, this input interface is suitable for receiving a transport stream transmitted from the content provider 50 through any suitable network (satellite, terrestrial, the Internet, etc. . . . ). In order to output at least one audio-video content which has been previously received through the input interface 21, the decoder also comprises an output interface 22. Typically, this output interface 22 is used by the data link 30 to connect the decoder 20 to the rendering device 40.

According to the subject-matter of the present description, the output interface 22 is suitable for outputting compressed content and the decoder 20 is configured to output any compressed content, in particular as it has been received at the input interface 21. Basically and in accordance to one embodiment, this means that the audio-video content 1 received at the input interface 21 are directed to the output interface 22 without being decompressed within the decoder 20. It should be understood that the output interface 22 is not limited to output compressed content only, but may be also suitable for outputting uncompressed data. More specifically, the output interface 22 is configured for outputting said compressed audio-video content 1, at least one application frame 4 relating to at least one application service, and control data 7. This control data 7 comprises identification data 3 and implementation data 5. The identification data 3 is used for identifying at least a part of the audio-video content 1 and/or a part of the at least one application frame 4. The implementation data 5 defines the rendering of the audio-video content 1 and/or the aforementioned at least one application frame 4.

The input interface 21 may be further configured for receiving the control data 7 and/or the at least one application frame 4 from a source external from the decoder 20. This input interface may be further configured for receiving external application data 12. Any of these data 7, 12 and any of these application frames 4 can be received through the input interface 21 in a compressed or uncompressed form.

According to one embodiment, the decoder 20 further comprises an application engine 24 for generating at least the control data 7. Said control data 7 describing the way to form an audio-video data 18 from said audio-video content and said at least one application frame 4. Alternatively, this application engine 24 may be configured to generate at least one application frame 4. Preferably, the application engine 24 is configured for generating the control data 7 and at least one application frame 4. The decoder 20 also comprises a sending unit 23 configured to send these application frames 4 and control data 7 towards the output interface 22. Typically, the sending unit 23 is also used to prepare data which has to be sent. Accordingly, the tasks of the sending unit 23 may be encoding such data, carrying out a packetisation of the application frames and control data, and/or preparing packet headers and/or stream headers.

In addition, the decoder 20 can comprise a database or a storage device 25 for storing application data 2 which can be used by the application engine 24 for generating the application frame(s) 4. Accordingly, the storage device can be regarded as being a library for storing predefined data usable by the application engine for generating application frames. The content of the storage device could also evolve, for instance by receiving additional or renewed application data from an external source such as the content provider 50.

According to another embodiment, the decoder 20 may comprise an input data link 26 for receiving external application data 12 into the application engine 24. Such external application data 12 can be processed together with internal application data provided by the storage device 25 or it can be processed instead of the internal application data. External application data 12 can be received from any source 60 external to the decoder 20 or external to the multimedia system 10. The external source 60 may be a server connected to the Internet, for instance in order to receive data from social networks (Facebook, twitter, LinkedIn, etc. . . . ), from instant messaging (skype, Messenger, Google talk, etc. . . . ), from sharing websites (YouTube, flickr, Instagram, . . . ) or any other social media. Other sources, such as phone providers, content providers 50 or private video monitoring sources could be regarded as being external sources 60.

Generally speaking, the application engine 24 is connectable to the storage device 25 and/or to at least one source external to the decoder 20 for receiving application data 2, 12 to be used for generating at least one application frame 4.

According to a further embodiment, the sending unit 23 is configured to send application frames 4 through an application sub-stream 14 which is distinct from any compressed audio-video content.

According to a variant, the decoder 20 further comprises a compression unit 28 configured to compress the aforementioned at least one application frame 4, more specifically to compress the application sub-stream 14 prior sending the application frame(s) 4 through the output interface 22. A shown in FIG. 2, the compression unit 28 could be located inside the sending unit 23 or outside this unit, for instance to compress data which forms the application frames 4 before preparing their delivery at the sending unit 23.

According to another variant, the decoder comprises a multiplexer 29 configured to multiplex the application sub-stream 14 together with the aforementioned at least one audio-video main stream, before outputting the main stream through the output interface 22. As shown in FIG. 2 by the dotted line extending from the multiplexer 29, the control data stream 17 could also be multiplexed with any other stream(s), namely with the application sub-stream 14, with the audio-video main stream(s) or with both the main stream(s) and the application sub-stream 14, for instance to output a single stream from the output interface 22.

In one embodiment, the application engine 24 or the sending unit 23 is further configured to insert control data 7 within the application sub-stream 14, so that this application sub-stream 14 carries both the application frame(s) 4 and control data 7. As already mentioned regarding the method disclosed in the present description, such an insertion can be carried out by various manners. For example, the insertion can be obtained by interleaving control data 7 with data concerning frames 4, or by placing control data 7 in at least one header (packet header and/or stream header) within the application sub-stream 14. Such an operation can be performed by the sending unit 23, as schematically shown by the dotted line coming from the control data stream 17 and joining the application data stream 14.

According to a variant, the application engine 24 or the sending unit 23 can be configured to send control data 7 through the control data stream 17, namely through a standalone or independent stream which is distinct from any other stream.

Furthermore, the decoder 20 may comprise other components, for example at least one tuner and/or a buffer. The tuner may be used for selecting a TV channel among all the audio-video main streams comprised in the transport stream received by the decoder. The buffer may be used for buffering audio-video data received from an external source, for example as external application data 12. The decoder may further comprise computer components, for example to host an Operating System and middleware. These components may be used to process application data.

As already mentioned regarding the corresponding method, the implementation data 5 may comprise data relating to target areas for displaying the audio-video content 1 and/or at least one application frame 4.

The implementation data 5 may define a priority which can be applied in case of overlaying displayable data. Such a priority may take the form of an implementing rule to be applied for rendering the audio-video content 1 and/or the aforementioned at least one application frame 4. According to such a priority parameter, it becomes possible to define which displayable data has to be brought to front or has to be sent to back in case of overlap.

The implementation data 5 may define a transparency effect applied on the audio-video content 1 and/or at least one application frame 4 in case of overlay.

The implementation data 5 may also allow to resize the audio-video content and/or at least one application frame 4. Such a resizing effect may be defined through a rule to be applied for rendering the audio-video content 1 and/or the aforementioned at least one application frame 4.

According to another embodiment, the decoder 20 may be configured to decrypt the audio-video content 1, especially in the case where the audio-video content is received in an encrypted form.

The present description also intends to cover the multimedia system 10 for implementing the method disclosed previously. In particular this multimedia system 10 can be suitable for implementing any of the embodiments of this method. To this end, the decoder 20 of this system 10 can be configured in accordance with any of the embodiments relating to this decoder.

Accordingly, the multimedia system 10 comprises at least a decoder 20 and a rendering device 40 connected to the decoder 20. The decoder 20 comprises an input interface 21 for receiving audio-video content 1 in a compressed form, and an output interface 22 for outputting audio-video content 1. The rendering device 40 is used for outputting audio-video data 18 at least from the aforementioned audio-video content 1, the at least one application frame 4 and the control data 7 which has been output from the decoder 20.

Accordingly, the decoder 20 of this multimedia system 10 is configured to transmit, to the rendering device 40 and through said output interface 22, at least one compressed audio-video content 1 as received by the input interface 21. The decoder 20 is further configured to transmit, through the same way or through a similar manner, at least one application frame 4, relating to at least one application service, and control data 7. In addition, the rendering device 40 is configured to decompress the audio-video content received from the decoder 20 and to process the application frame 4 in accordance with the control data 7 in order to form all or part of the aforementioned audio-video data 18. Instead of processing the application frame 4, the receiving device 40 may process the decompressed audio-video content 1 in accordance with the control data 7. Alternatively, the receiving device 40 may process the audio-video content 1 and the aforementioned at least one application frame 4 in accordance with the implementation data 7. As with the method, the control data 7 comprises identification data 3 and implementation data 5. The identification data 3 is used for identifying at least a part of the audio-video content 1 and/or a part of the at least one application frame 4. The implementation data 5 defines the rendering of at least one of the audio-video content 1 and the aforementioned at least one application frame 4.

In the event that the decoder 20 of this multimedia system comprises a multiplexer 29, the rendering device 40 of this system will further comprise a demultiplexer 49 (FIG. 1) for demultiplexing the multiplexed stream received from the decoder. Similarly, if the decoder 20 of the multimedia system 10 comprises a compression unit 28, the rendering device 40 of the multimedia system 10 will further comprise a decompression unit 48 for decompressing at least the application sub-stream 14. Furthermore, in the case where the multimedia system 10, in particular the decoder 20, is designated for receiving encrypted audio-video content, the rendering device 40 may further comprise security means 47 for decrypting the encrypted content.

Besides, if all or part of the streams 1, 14 and 17 are multiplexed together, the demultiplexer 49 of the rendering device 40 will first process the input stream before to decompress any stream, or even before to decrypt the audio-video content if it is encrypted. In any case, the decompression will occur after the decryption and demultiplexing operations.

Whatever the subject-matter of the present description, it should be noted that in the case where the audio-video main stream is encrypted, it will be preferably decrypted in the decoder 20 instead of being decrypted in the rendering device 40. Accordingly, security means 47 could be located within the decoder 20 instead of being located in the rendering device 40 as shown in FIG. 1.

Preferably, the security means 47 is not limited to undertake decryption processes but it will be able to perform other tasks, for example some tasks relating to conditional access for processing digital rights management (DRM). Accordingly, the security means may include a conditional access module (CAM) which may be used for checking access conditions with respect to subscriber's rights (entitlements) before performing any decryption. Usually, the decryption is performed by means of control words (CW). The CWs are used as decryption key and are carried by Entitlement Control Messages (ECM).

The security means can be a security module, such as a smart card that can be inserted into a Common Interface (e.g., DVB-CI, CI+). This common interface can be located in the decoder or in the rendering device. The security means 47 could also be regarded as being the interface (e.g., DVB-CI, CI+) for receiving a security module, in particular in the case where the security module is a removable module such as a smart card. More specifically, the security module can be designed according to four distinct forms.

One of the forms is a microprocessor card, a smart card, or more generally an electronic module which could have the form of a key or a tag for example. Such a module is generally of a removable from and connectable to the receiver. The form with electric contacts is the most used, but does not exclude a link without contact, for instance of the type ISO 14443.

A second known design is that of an integrated circuit chip placed, generally in a definitive and irremovable way, in the printed board of the receiver. An alternative is constituted by a circuit mounted on a base or connector, such as a connector of a SIM module.

In a third design, the security module is integrated into an integrated circuit chip also having another function, for instance in a descrambling module of the decoder or the microprocessor of the decoder.

In a fourth embodiment, the security module is not realized in a hardware form, but its function is implemented in a software form only. This software can be obfuscated within the main software of the receiver.

Given that in the four cases the function is identical, although the security level differs, we will refer to the security module in whichever way appropriate to realise its function or the form that can take this module. In the four designs described above, the security module has the means for executing a program (CPU) stored in its memory. This program allows the execution of the security operations, verifying the rights, effecting a decryption or activating a decryption module etc.

The present description also intends to cover the rendering device 40 of the above-described multimedia system 10. To this end, a further object of the present description is a rendering device 40 for rendering compressed audio-video content 1 and at least one application frame 4 relating to at least one application service. More specifically, the rendering device 40 is configured for rendering audio-video data 18 from compressed audio-video content 1, the aforementioned at least one application frame 4 and identification data 3 for identifying at least a part of said audio-video content 1 and/or a part of said at least one application frame 4.

To this end, the rendering device 40 comprises means, such as an input interface or a data input, for receiving the compressed audio-video content 1, at least one application frame 4 and the identification data 3. This rendering device further comprises a decompression unit 48 for decompressing at least the compressed audio-video content 1. The rendering device 40 also comprises a control unit 44 configured to process the audio-video content 1 and/or at least one application frame 4. The rendering device 40 is characterized in that the input interface is further configured to receive implementation data 5 defining how to obtain the audio-video data 18 from: the audio-video content 1 and/or the at least one application frame 4. Moreover, the control unit 44 is further configured to process the audio-video content 1 and/or at least one application frame 4 in compliance with identification data 3 and implementation data 5. More specifically, the control unit 44 is configured to process the audio-video content 1 and/or at least one application frame 4, identified by the identification data 3, in compliance with implementation data 5. Preferably, the identification data 3 and the implementation data 5 are comprised in control data 7, as mentioned before regarding the corresponding method. The control data 7 describes the way to form the audio-video data 18 from the audio-video content 1 and the aforementioned at least one application frame 4. As already explained, the identification data 3 is used for identifying at least a part of the audio-video content 1 and/or a part of at least one application frame 4. The implementation data 5 defines the rendering of at least one of the audio-video content 1 and the aforementioned at least one application frame 4. The “rendering” concept is the same as that explained regarding the corresponding method. Given that the application frame(s) 4 and the audio-video content 1 (once decompressed) are displayable data 15, the rendering device is fully able to read such displayable data. In addition, since the control unit 44 may use system software for executing control data 7, the rendering device is able to provide a particular presentation to the displayable data 15 by applying the implementation data 5 to at least a part of these displayable data 15. Thus, the rendering device 10 is able to generate an intelligible audio-video data 18 which can be regarded as a personalized single stream. Once generated, the audio-video data 18 can be output from the rendering device 40 as a single common stream displayable on any screen.

Advantageously, the rendering device 40 is able to render an enhanced audio-video content via said audio-video data 18, given that the audio-video content 1 and the application frame(s) 4 have been arranged and combined together in accordance with the control data 7, especially in accordance with the implementation data 5.

As mentioned before regarding the multimedia system 10, the rendering device 40 may further comprise security means 47 for decrypting any encrypted content. As already mentioned, the application frames 44 could be received through an application sub-stream 14. Given that such a sub-stream 14 could be multiplexed with any audio-video main stream(s) before being received by the rendering device 40, therefore the rendering device 40 could further comprise a demultiplexer 49 for demultiplexing any multiplexed stream.

Whatever the subject-matter of the present description, it should be noted that the embodiments may be combined with each other in any manner.

Although an overview of the inventive subject matter has been described with reference to specific example embodiments, various modifications and changes may be made to these embodiments without departing from the broader spirit and scope of embodiments of the present invention. For example, various embodiments or features thereof may be mixed and matched or made optional by a person of ordinary skill in the art. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

1. A decoder comprising:
an input interface for receiving audio-video content in a compressed form; and
an output interface for outputting said compressed audio-video content, at least one application frame relating to at least one application service, and control data, said control data comprising identification data and implementation data, said identification data being used for identifying at least a part of said audio-video content and/or a part of said at least one application frame, and said implementation data defining a rendering of at least one of said audio-video content and said at least one application frame.

2. The decoder of claim 1, further comprising an application engine for generating at least said control data.

3. The decoder of claim 1, wherein said input interface is further configured to receive said at least one application frame from a source external to the decoder.

4. The decoder of claim 2, wherein said application engine is further configured to generate said at least one application frame.

5. The decoder of claim 1, further comprising a compression unit configured to compress said at least one application frame.

6. The decoder of claim 1, wherein said implementation data comprises data relating to target areas for displaying at least one of said audio-video content and said at least one application frame.

7. The decoder of claim 1, wherein said implementation data defines a priority which can be applied in case of overlapping displayable data.

8. The decoder of claim 7, wherein said implementation data defines a transparency effect applied on at least one of said audio-video content and said at least one application frame in case of overlay.

9. The decoder of claim 1, wherein said implementation data enables the resizing of at least one of said audio-video content and said at least one application frame.

10. The decoder of claim 1, wherein the decoder is configured to decrypt said audio-video content if said audio-video content is received in an encrypted form.

11. A method for rendering audio-video data from audio-video content and at least one application frame relating to at least one application service, comprising:
receiving, by the decoder, said audio-video content in compressed form; and
outputting from said decoder, the audio-video content in said compressed form, at least one application frame relating to at least one application service, and control data, wherein said control data comprises identification data and implementation data in said control data, said identification data being used for identifying at least a part of said audio-video content and/or a part of said at least one application frame, and said implementation data defining the rendering of at least one of said audio-video content and said at least one application frame.

12. The method of claim 11, wherein said control data is generated by the decoder.

13. The method of claim 10, wherein said at least one application frame is received by the decoder from a source external to said decoder.

14. The method of claim 10, wherein said at least one application frame is generated by the decoder.

15. The method of claim 10, wherein said at least one application frame is compressed by the decoder before to be output from the decoder.

16. A rendering device for rendering audio-video data from compressed audio-video content, at least one application frame relating to at least one application service, and identification data for identifying at least a part of said audio-video content and/or a part of said at least one application frame, comprising:
an input interface configured to receive said compressed audio-video content, said at least one application frame, said identification data, and implementation data defining how to obtain said audio-video data from at least one of said audio-video content and said at least one application frame;
a decompression unit configured to decompress at least said compressed audio-video content; and
a control unit configured to process at least one of said audio-video content and said at least one application frame in compliance with said identification data and said implementation data.
